(19) United States
(12) Patent Application Publication
(10) Pub. No.: US 2024/0246397 A1
(43) Pub. Date: Jul. 25, 2024

(54) AIR-CONDITIONING SYSTEM FOR A VEHICLE

(71) Applicant: Siemens Mobility GmbH, München (DE)

(72) Inventors: Norbert Kleff, Essen (DE); Daniel Vreydal, Alsdorf (DE)

(21) Appl. No.: 18/251,573

(22) PCT Filed: Oct. 13, 2021
(86) PCT No.: PCT/EP2021/078312

§ 371 Date: May 3, 2023

(30) Foreign Application Priority Data
Nov. 3, 2020 (DE) 10 2020 213 783.8

(51) Int. Cl. B60H 1/32; B60H 1/00

(52) U.S. Cl. CPC B60H 1/3233; B60H 1/00028

(57) ABSTRACT

An air-conditioning system for a vehicle has an air treatment part with an evaporator, past which an air stream to be conditioned is conducted by a supply air fan. A condensate collection trough collects the condensate which forms on the evaporator. The condensate collection trough is connected to an outlet opening to its surroundings in order to discharge collected condensate. A discharge of condensate from the condensate collection trough through the outlet opening is assisted by way of a compressed air device which is arranged in such a way that it acts on the collected condensate in the direction of the surroundings of the condensate collection trough.

The invention relates to an air-conditioning system for a vehicle, having an air treatment part, one evaporator, past which an air stream to be conditioned is guided by means of a supply air fan, and a condensate collection trough, in which condensate which accumulates on the evaporator is collected, wherein the condensate collection trough is in communication with an outlet opening to its environment in order to discharge collected condensate, and to a vehicle equipped with such an air-conditioning system.

When operating such an air-conditioning system in cooling mode, a considerably quantity of condensed water precipitates in the region below the evaporator (inner heat exchanger). This water is typically collected in a condensate collection trough and then discharged from the air-conditioning system in a controlled manner. In the case of a pressure-sealed vehicle, for example a high-speed train, the provided outlet opening of the condensate collection trough or an inserted drainage line, with the outlet opening arranged at its end, cannot be designed such that it is open to the environment of the condensate collection trough, since a pressure surge might otherwise penetrate into the vehicle via the outlet opening. It is advisable here to ensure a water column with a suitable height so that the pressure surge can be reliably prevented from penetrating into the vehicle. The use of a controllable valve is suitable for ensuring such a water column.

In such an air-conditioning arrangement, there is the option of setting the pressure conditions in the region of the condensate collection trough in such a way that a considerable negative pressure exists above the condensate water level. This in turn hinders or even prevents the controlled discharge of the condensate to the outside. Such a negative pressure forms, in particular, when the supply air fan used to convey the air stream is arranged downstream of the evaporator (“induced draft fan arrangement”).

This can result in an increase in the condensate water level in the air-conditioning device in continuous cooling mode, wherein, in some circumstances, defined dry areas within the air-conditioning system and, if applicable, also within a connected channel system can become flooded.

Taking this as a starting point, in the case of an air-conditioning system of the type mentioned at the outset, the invention is based on the object of enabling a controlled discharge of collected condensate water even under difficult pressure conditions in the air-conditioning system.

This object is achieved by an air-conditioning system having the features of claim 1.

Accordingly, the air-conditioning system described at the outset is notable in that the discharge of condensate which has collected in the condensate collection trough through the outlet opening is assisted by means of a compressed air device, which is arranged in such a way that it acts on the collected condensate in the direction of the environment of the condensate collection trough.

The provided compressed air device therefore assists the discharge of collected condensate water from the condensate collection trough. The compressed air device is capable of altering the pressure conditions in the region of the outlet opening/the drainage line via appropriate pressure surges in such a way that condensate water which has collected in the condensate collection trough can make its way outside the air-conditioning system in an unhindered manner through the outlet opening.

The compressed air device is preferably formed by an ejector nozzle. This is in turn preferably arranged within the air treatment part of the air-conditioning system and, for example, directed from above onto an outlet opening at the base.

When using a drainage line, in which the outlet opening to the environment is located at the end which is remote from the condensate collection trough, the ejector nozzle can also be arranged within this drainage line.

The flow of compressed air from the ejector nozzle is advantageously controlled by means of a solenoid valve in a compressed air supply line for the electric nozzle. This solenoid valve can preferably be actuated in a time-controlled manner or on the basis of a fill level switch arranged in the condensate collection trough. A time control for opening the solenoid valve would then be based on empirical values for the time intervals at which assisted discharge of the condensate water is required. In contrast, the fill level switch signals that a certain condensate water level in the condensate water trough has been reached, so the solenoid valve is opened when a predetermined fill level has been reached so that a pressure surge is realized via the ejector nozzle.

The outlet opening for discharging collected condensate water can be provided directly in a base region of the condensate collection trough and designed in such a way that a water column can be maintained above the outlet opening for pressure-tightness of the air-conditioning system. This embodiment relates in particular to pressure-sealed vehicles such as high-speed trains. It is precisely for such applications of the invention that significant advantages arise in terms of discharging condensate water.

Alternatively, the outlet opening can also be provided at the end of a drainage line which is connected to the condensate collection trough and in which a water column can be maintained for pressure-tightness of the air-conditioning system.

The invention is particularly advantageous if, in relation to a flow direction of the air stream, the supply air fan is arranged downstream of the evaporator. Specifically, a considerable negative pressure then forms above the fill level of the condensate water and counteracts the discharge of condensate water through the outlet opening.

In terms of the vehicle, the object specified above is achieved by a vehicle having the features of claim 8. In particular, a rail vehicle is equipped as standard with a compressed air reservoir (e.g. for pneumatic actuation of vehicle doors). The compressed air device of the air-conditioning system is preferably connected to this compressed air reservoir. To set a suitable pressure for operating the compressed air device, in particular the ejector nozzle, a throttle can be provided, which is used, for example, to ensure an operating pressure of 3 bar for the ejector nozzle. A typical air pressure in a main air line of a rail vehicle is between 6 and 10 bar here.

An exemplary embodiment of the invention is explained in more detail below with reference to the drawings, in which:

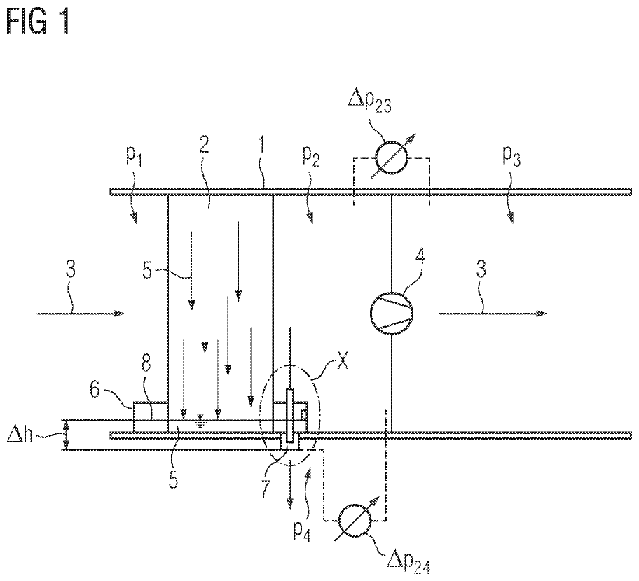

FIG. 1 shows a schematic view of an air treatment part of an air-conditioning system and

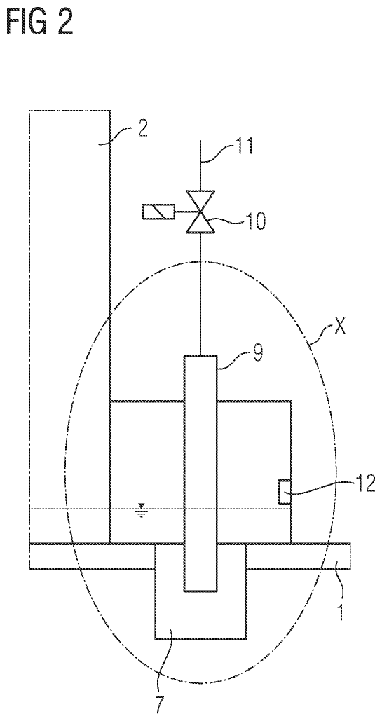

FIG. 2 shows a schematic view of a detail of the air treatment part of FIG. 1.

As can be seen in FIG. 1, an evaporator 2 is arranged within a housing 1 of an air treatment part of an air-conditioning system. An air stream 3, which is to be conditioned in terms of its temperature, for example, is conveyed past the evaporator 2, specifically with the aid of a supply air fan 4. In relation to the flow direction of the air stream 3, the supply air fan 4 is arranged downstream of the evaporator 2. In this way, a so-called “induced draft arrangement” of the supply air fan 4 relative to the evaporator 2 is realized.

An interaction between the moisture-containing air stem 3 and the evaporator 2 causes condensate 5 to precipitate on the evaporator 2. To collect the condensate 5, a condensate collection trough 6 is provided, which is arranged below the evaporator 2 so that the condensate 5 makes its way into the condensate collection trough 6 under the effect of gravity.

The present exemplary embodiment demonstrates the application in the case of a pressure-tight high-speed train, in which, in particular, pressure surges entering the air-conditioning system from the outside are to be prevented. For this reason, the condensate collection trough 6 is not emptied immediately. Instead, the drainage properties of the condensate collection trough 6 are selected such that a water column remains above an outlet opening 7, which is provided at the base of the condensate collection trough 6. The vertical extent of the water column is determined according to the height difference Δh between the fill level 8 for the condensate 5 in the condensate collection trough 6 and the height of the outlet opening 7.

The pressure conditions in the air treatment part of the air-conditioning system are as follows: before reaching the evaporator 2, the air stream 3 has a pressure p₁. The supply air fan 4 arranged on the suction side of the evaporator 2 results in a pressure p₂ which, to guide the air stream 3 past the evaporator 2, is lower than the pressure P₁. After passing the supply air fan 4, the air stream 3 has a pressure p₃. It should moreover be taken into account that the condensate 5 which has collected in the condensate collection trough 6 has a hydrostatic pressure, which is determined by the height of the water column Δh. If the condensate 5 is to be discharged from the condensate collection trough 6 via the outlet opening 7, the hydrostatic pressure of the condensate 5 in the condensate collection trough 6 must be greater than a pressure difference Δₚ₂₄ between the pressure p₂ and an external pressure p₄ which exists in the environment of the air treatment part/condensate collection trough 6. In particular, condensate 5 cannot be discharged from the outlet opening 7 if:

$$ρ \times g \times {Δ}_{p 24} .$$

To enable drainage of the condensate collection trough 6 despite such pressure conditions in the air-conditioning system, a compressed air device is provided, specifically in 11 the region of the detail X (region of the water column) of FIG. 1, which is now explained in more detail with reference to FIG. 2.

As FIG. 2 shows, as an exemplary embodiment for a compressed air device, a vertically arranged ejector nozzle 9 is arranged directly adjacent to the evaporator 2 on its suction side, which ejector nozzle projects downwards into the water column of condensate 5 above the outlet opening 7 and can emit compressed air surges in the direction of the outlet opening 7.

The ejector nozzle 9 is connected to a compressed air reservoir (not illustrated) via a controllable solenoid valve 10 and a compressed-air supply line 11. Such a compressed air reservoir is provided as standard on rail vehicles, for example, so that, with regard to its compressed-air supply, the ejector nozzle can access a compressed air reservoir which is already present. To provide a suitable operating pressure for the ejector nozzle 9, it is possible to provide a throttle (not illustrated) so that, starting from a standard air pressure of 6 to 10 bar, for example, an operating air pressure of 3 bar can be provided for the injector nozzle 9. The extent to which the use of a nozzle is required depends on the air pressure in the compressed air reservoir of the vehicle in question.

The solenoid valve 10 can be actuated, for example, in a time-controlled manner or with the aid of a fill level switch arranged in the condensate collection trough 6. The figures show an exemplary embodiment in which an activation of the fill level switch 12 triggers an actuation of the solenoid valve 10 so that compressed air is expelled via the ejector nozzle 9 in the direction of the outlet opening 7. In this way, the compressed-air-operated ejector nozzle 9 delivers a driving force for discharging the condensate 5 from the condensate collection trough 6 via an impulse exchange.

In an exemplary embodiment which is not illustrated in more detail, the condensate collection trough 6 can be connected to a remotely situated outlet opening, specifically via a drainage line. In this case, it is possible for the ejector nozzle 9 to be arranged at a suitable point within this drainage line. The principle of assisting the drainage of the condensate collection trough 6 here remains unaltered from the exemplary embodiment described above.

1-10. (canceled)

11. An air-conditioning system for a vehicle, the air-conditioning system comprising:
an air treatment part having an evaporator and a condensate collection trough;
a supply air fan configured to cause an air stream to flow past said evaporator, wherein condensate that precipitates on said evaporator is collected in said condensate collection trough, and wherein said condensate collection trough is in communication with an outlet opening to an environment thereof for enabling a discharge of the condensate collected in said condensate collection trough; and
a compressed air device configured to assist in a discharge of the condensate from said condensate collection trough through said outlet opening, said compressed air device being configured to act on the condensate in a direction toward the environment of the condensate collection trough.

12. The air-conditioning system according to claim 11, wherein said compressed air device comprises an ejector nozzle.

13. The air-conditioning system according to claim 12, which comprises a solenoid valve in a compressed air supply line for said ejector nozzle, wherein a flow of compressed air from said ejector nozzle is controlled by said solenoid valve.

14. The air-conditioning system according to claim 13, wherein said solenoid valve is actuated in a time-controlled manner.

15. The air-conditioning system according to claim 13, which further comprises a fill level switch arranged in said condensate collection trough, and wherein said solenoid valve is actuated by said fill level switch.

16. The air-conditioning system according to claim 11, wherein said outlet opening is formed directly in a base region of said condensate collection trough and is configured to maintain a water column above said outlet opening for a pressure-tightness of the air-conditioning system.

17. The air-conditioning system according to claim 11, wherein said outlet opening is provided at an end of a drainage line that is connected to communicate with said condensate collection trough and in which a water column is maintained for pressure-tightness of the air-conditioning system.

18. The air-conditioning system according to claim 11, wherein said supply air fan is arranged downstream of said evaporator in a direction of flow of the air stream.

19. A vehicle, comprising an air-conditioning system according to claim 11.

20. The vehicle according to claim 19, which comprises a compressed air reservoir, wherein said compressed air device of said air-conditioning system is connected to said compressed air reservoir.

21. The vehicle according to claim 20, which comprises a throttle connected between said compressed air device of said air-conditioning system and said compressed air reservoir.
